(19) United States
(12) Patent Application Publication
(10) Pub. No.: US 2010/0297432 A1
(43) Pub. Date: Nov. 25, 2010

(54) ARTICLE AND METHOD OF MANUFACTURING RELATED TO NANOCOMPOSITE OVERLAYS

(76) Inventors: Andrew J. Sherman, Kirtland Hills, OH (US); Peter G. Engleman, Painesville, OH (US)

Correspondence Address: Brooks Kushman P.C. / LA, 1000 Town Center, 22nd Floor, Southfield, MI, 48075, US

(21) Appl. No.: 12/785,397

(22) Filed: May 21, 2010

Related U.S. Application Data
(60) Provisional application No. 61/180,530, filed on May 22, 2009.

(51) Int. Cl. B32B 5/02; B05D 3/02; B05D 1/12; B32B 18/00; B32B 15/00

(52) U.S. Cl. 428/325; 427/180; 428/426; 428/323

(57) ABSTRACT

Composite layers are formed on substrates, particularly heat sensitive substrates. A uniform composite mixture is prepared from powdered nanoscale ceramic phase particulates and a particulate matrix phase precursor that contains a fusible matrix former. The composite mixture is applied to the substrate surface where it forms a composite mixture layer that is thin relative to the substrate. The composite mixture layer is subjected to a rapid high flux heating pulse of energy to fluidize the fusible matrix former, followed by a rapid quenching step that occurs at least in part because of heat transfer to the substrate, but without significantly damaging the overall temper properties of the substrate. The nanoscale ceramic phase is present in the composite layer in an amount that is greater than its percolation threshold, so the resulting fused composite layer does not tend to flow or sag while the matrix former is in the fluid state. Also, the grain size of the matrix is minimized by the presence of the nanoscale ceramic phase.

### CROSS-REFERENCE TO RELATED APPLICATIONS

This application claims the benefit of U.S. provisional Application No. 61/180,530 filed May 22, 2009, which provisional Application is hereby incorporated herein by reference as though fully set forth hereat.

### TECHNICAL FIELD

The invention relates to the formation of layers on substrates wherein intense pulsed heating is applied to fluidize a layer that contains a nanoscale ceramic phase, which ceramic phase is present in at least its percolation threshold.

### BACKGROUND

Manufactured products contain components that are constructed of high strength alloys. These high strength alloys are often subject to corrosion, wear, and thermal degradation, particularly in corrosive or other hostile environments. Coatings of one kind or another had been previously proposed for protecting such high strength alloy components. These previous expedients were generally less than fully satisfactory by reason of providing inadequate protection in certain environments, or impairing the properties of the components for certain uses.

Various expedients had previously been proposed that involved the rapid heating of a layer to fuse it. For example, Sikka et al. U.S. Pat. Nos. 6,432,555, 6,667,111, and 6,174,388, describe the rapid infrared heating of a surface layer while having little or no temperature effect on other parts of the object. Infrared heating at 250 kilowatts per square meter (kW/m²) (25 Watts per square centimeter (W/cm²)) or more at a rate of up to 200 degrees centigrade per second to effect a physical, chemical, or phase change in the surface layer while leaving the base layer intact is suggested. Sintering of a horizontal layer of powdered metal on a moving belt is disclosed.

Serlin U.S. Pat. No. 4,212,900 discloses the melting of alloying powder onto the surface of a substrate by applying a beam of high intensity energy, such as a laser, for a short period of time. This is said to be a surface alloying process. The main body of the substrate acts as a heat sink to rapidly dissipate the heat. Rapid cooling is disclosed to avoid “running” of the molten alloy that might distort the surface.

Deshpande et al. U.S. Pat. No. 6,939,576, which is hereby incorporated herein by reference as though fully set forth hereat, disclose the deposition of polymers from a fine spray on a substrate accompanied by the substantially simultaneous application of thermal energy to evaporate solvent, fuse, or cure the polymers. The layers may include finely divided particulate matter such as oxides, nitrides, or carbides to modify the characteristics of the layer.

Jiang et al. U.S. Pat. No. 7,345,255, which is hereby incorporated herein by reference as though fully set forth hereat, includes a description of the application of a carbide or boride-reinforced composite overlay, where these borides and carbides may be formed in-situ by the reaction of ferrochrome or ferrotitatium with carbon or boron, and/or by the addition of coarse hard particles. This may result in a bi-modal particle size distribution. The overlay is fused to a substrate to form a metallurgical bond and provide a wear and corrosion resistant overlay.

If any disclosure in any document that is incorporated herein by references contradicts or conflicts in any way with any disclosure that is directly set forth herein, the disclosure set forth herein shall control over any disclosure that is only incorporated by reference.

Those concerned with these matters recognize the need for improved methods and composite layers, particularly for application to heat sensitive substrates.

### SUMMARY

The present invention has been developed in response to the current state of the art, and in particular, in response to these and other problems and needs that have not been fully or completely solved by currently available expedients. The present invention to effectively resolve at least the problems and shortcomings identified herein. Embodiments are particularly suitable for use in forming fused composite layer from composite powdered material compositions on heat sensitive substrates. In certain embodiments, the fused composite layers are in the form of micro- or nanocrystalline films on the substrates. The composite layer along with the substrate that it overlays may be welded, formed, or processed to form a finished article.

Some embodiments of the present invention provide a method of manufacturing a composite layer containing a nanoscale ceramic phase substantially uniformly dispersed in a metal matrix phase. This method comprises selecting a matrix phase precursor. The matrix phase precursor comprises metallic powder that is fusible under a pulse heating condition. Provisions are made for providing the nanoscale ceramic phase, and a composite mixture that includes at least the matrix phase precursor is applied to a substrate. The substrate has thermally degradable physical properties. The composite mixture that is applied to the substrate is sufficiently adhered to the substrate to remain substantially where applied until it is subjected to the pulse heating condition. In some embodiments a powdered ceramic is provided in the composite mixture, and in certain other embodiments a ceramic phase precursor is provided in the composite mixture, and the nanoscale ceramic phase is allowed to precipitate in the fusion layer

The composite mixture is subjected to a pulse heating condition. The pulse heating condition comprise applying a heat flux of from about 150 to 3,500 watts per square centimeter for a period of from under 0.1 second to about 10 seconds resulting in a fusion layer in which the matrix phase precursor is fluidized and the nanoscale ceramic phase is dispersed substantially uniformly in the fluidized matrix. The fusion layer remains on the substrate without significant slumping or beading. The nanoscale ceramic phase is present in an amount above about its percolation threshold. The fusion layer is fluidized to a state of substantially full density where there is substantially no open porosity.

The fusion layer is quenched to form the finished composite layer. Quenching comprising allowing enough heat to transfer from the fusion layer to solidify the fusion layer without significantly degrading the thermally degradable physical properties of the substrate. This heat transfer involves at least allowing heat to flow conductively from the fusion layer to the substrate. Generally, some heat is also transferred by radiation from the fusion layer. Cooling gas may also be applied to the fusion layer so that some heat is dissipated by convection. The resulting composite layer is bonded to the surface of the substrate.

Some embodiments comprise adding a nanoscale powdered ceramic phase to the matrix phase precursor. Further embodiments comprise allowing the nanoscale ceramic phase to precipitate in the fusion layer. Where the ceramic phase is formed as a precipitate during the application of heat flux to the composite mixture on the substrate, the components, such as conventional thermally reactive ceramic precursors, that form the ceramic phase are provided in the composite mixture. In additional embodiments, the ceramic phase has a nanoscale:microscale bimodal particle size distribution in the finished composite layer of from approximately 3 to 100 nanometers and from approximately 1 to 1,000 microns. The nanoscale ceramic phase is present in an amount of from approximately 0.05 to 15 volume percent, and the total volume percent of the bimodal ceramic phase being less than about 85 percent of the total volume of the composite layer.

In certain embodiments, relative motion is established between the substrate and the source of the heat flux so the pulsed heating condition that the fusion layer sees occurs by reason of this relative movement. In some embodiments the application of the heat flux includes applying a heat flux from an infrared, radio frequency or laser heating source. In additional embodiments, the composite mixture may be subjected to more than one pulse heating condition. According to certain embodiments, enough total heat is applied to the composite mixture to raise the temperature of the fusion layer to from approximately 100 to 150 percent of the melting point of the metal in the matrix phase precursor.

Certain embodiments comprise a composite layer on a substrate, wherein the composite layer is substantially fully dense and pore free, and comprises a nanoscale ceramic phase substantially uniformly dispersed in a metallic matrix. The nanoscale ceramic phase is present in an amount of at least about its percolation threshold and from about 0.5 to 15 volume percent. In certain further embodiments the metallic matrix is an amorphous alloy. In embodiments where the metallic matrix has a generally crystalline structure the average grain size of from about 0.5 to 100 microns, or in further embodiments, less than about 30, or less than about 10, or less than about 5, or less than about 1 micron. According to certain further embodiments, the metallic matrix has an average grain size of less than about 5 microns, and the nanoscale ceramic phase is present in an amount of from about 0.5 to 5 volume percent based on the total volume of the finished composite layer. In some embodiments, in addition to a nanoscale ceramic phase, the composite layer also includes a micron-scale ceramic phase in an amount of from approximately 1 to 75 volume percent with an average particle size of from 1 to 1,000 microns. According to certain embodiments, the metallic matrix comprises metallic elements, or metallic alloys such as corrosion resistant metal alloys.

Certain embodiments comprise a method of manufacturing a composite layer containing a nanoscale ceramic phase in a non-metallic matrix phase. According to these embodiments a matrix phase precursor is selected, which matrix phase precursor comprises polymeric powder that is fluidizable under a pulse heating condition. Provisions are made for the nanoscale ceramic phase. A composite mixture that includes at least the matrix phase precursor is applied to a substrate. The polymeric powder has a decomposition temperature above which the polymer powder decomposes, and the substrate has thermally degradable physical properties. The composite mixture is sufficiently adhered to the substrate to remain substantially where applied until subjected to the pulse heating condition. Above there decomposition temperatures polymers tend to vaporize or return to elemental carbon.

According to certain embodiments, the composite mixture is subjected to the pulse heating condition by applying a heat flux of from about 150 to 500 or 1,700 Watts per square centimeter for a period of from under 0.1 second to about 10 seconds, and until the composite mixture reaches a temperature below about the decomposition temperature of the polymeric powder. Where the fusion layer is substantially transparent to visible light, the ceramic phase tends to absorb the heat energy, thus promoting fluidization with the application of a minimum amount of heat. This results in a fluidized layer in which the matrix phase precursor is fluidized to form a fluidized matrix. The nanoscale ceramic phase is dispersed in the fluidized matrix. The fluidized layer remains on the substrate without significant slumping or beading. The nanoscale ceramic phase is present in an amount above about its percolation threshold, which stiffens the fluidized layer and prevents significant slumping or beading.

The fluidized layer is quenched to form the composite layer. Quenching comprising allowing enough heat to transfer from the fluidized layer to solidify the fluidized layer without significantly degrading the thermally degradable physical properties of the substrate. According to certain embodiments, quenching includes allowing the matrix phase precursor to cross-link to a solid thermoset condition. In certain further embodiments, the matrix phase precursor includes a thermoplastic polymer, and quenching includes allowing the thermoplastic polymer to become solid. According to certain embodiments, the matrix phase precursor includes an organic polymer, or an inorganic organic polymer, or a thermosetting polymer, or mixtures thereof.

Certain embodiments comprise a composite layer on a substrate, wherein the composite layer is substantially pore free and comprises a nanoscale ceramic phase in a solid phase non-metallic matrix. The nanoscale ceramic phase is present in an amount of at least about its percolation threshold and from about 0.05 to 15 volume percent based on the total volume of the composite layer. In certain further embodiments the composite layer comprises a ceramic phase having a nanoscale:micron-scale bimodal particle size distribution of from approximately 3 to 100 nanometers and from approximately 1 to 1,000 microns, respectively. The nanoscale ceramic phase is present in an amount of from approximately 0.05 to 15 volume percent, and the total volume percent of the entire ceramic phase is less than about 85 percent based on the total volume of the composite layer.

According to certain embodiments, a method of manufacturing a composite layer containing a nanoscale ceramic phase in a metal matrix phase comprises selecting a matrix phase precursor that comprises a metallic powder that is fusible under a pulse heating condition, and has a metallic melting point. A ceramic phase precursor is provided. The ceramic phase precursor comprises nanoscale ceramic particles with an average particle size of from approximately 3 to 100 nanometers, and a ceramic melting point that is at least 100 degrees Celsius above the metallic melting point of the metallic powder. The matrix phase precursor and ceramic phase precursor are mixed to form a composite mixture that is substantially uniform. The composite mixture is applied to a substrate to form a composite mixture layer on that substrate. The substrate has thermally degradable physical properties that degrade at temperatures below metallic melting point of the metallic powder. The composite mixture layer is sufficiently adhered to the substrate to remain substantially where applied until subjected to the pulse heating condition. The composite mixture layer is subjected to a pulse heating condition by applying a heat flux of from about 150 to 3,500, or in some embodiments 700 to 1,700 watts per square centimeter for a period of from under 0.1 second to about 10 seconds. This results in the formation of a fusion layer in which the metallic powder in the matrix phase precursor is fluidized, and the nanoscale ceramic phase is substantially uniformly dispersed in a resulting fluidized matrix. The fusion layer remains on the substrate without significant slumping or beading. The nanoscale ceramic phase is present in the fusion layer in an amount above about its percolation threshold. The fusion layer is quenched to form a composite layer. The quenching comprising allowing enough heat to transfer from the fused layer to solidify the fusion layer without significantly degrading the thermally degradable physical properties of the substrate.

The detailed descriptions of specific embodiments of the invention are intended to serve merely as examples, and are in no way intended to limit the scope of the appended claims to these described embodiments. Accordingly, modifications to the embodiments described are possible, and it should be clearly understood that the invention may be practiced in many different ways than the embodiments specifically described below, and still remain within the scope of the claims.

### BRIEF DESCRIPTION OF THE DRAWINGS

Further advantages of the present invention may become apparent to those skilled in the art with the benefit of the following detailed description of certain specific embodiments and upon reference to the accompanying drawings in which:

FIG. 1 is a diagrammatic flow chart depicting an embodiment of a method according to the present invention wherein a ceramic phase is mixed in powder form with powdered matrix precursor.

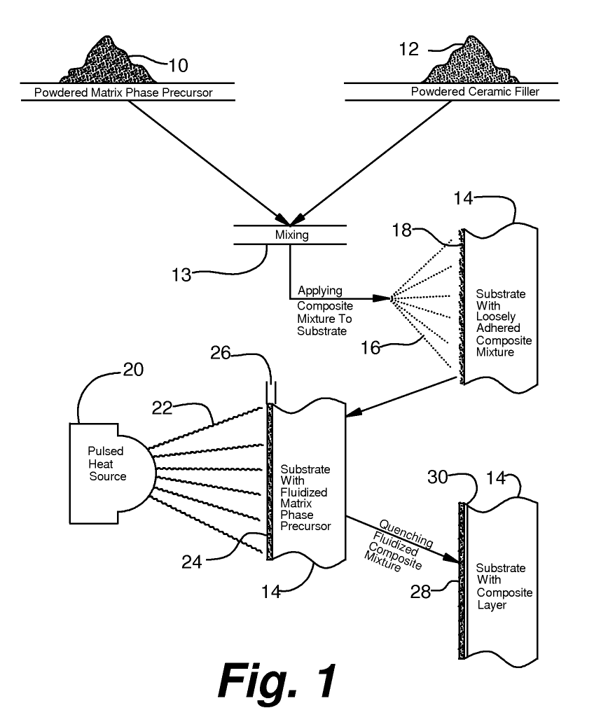

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications.

### DETAILED DESCRIPTION

As required, detailed embodiments of the present invention are disclosed herein; however, it is to be understood that the disclosed embodiments are merely exemplary of the invention that may be embodied in various and alternative forms. The use of words and phrases herein with reference to specific embodiments, as will be understood by those skilled in the art, does not limit the meanings of such words and phrases to those specific embodiments. Words and phrases herein have their ordinary meanings in the art, unless a specific definition is set forth at length herein. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Referring particularly to the drawings, a mass of powdered matrix phase precursor is indicated at 10, and a mass of powdered ceramic filler is indicated at 12. The mixing of these to form a uniform mixture is indicated at 13. Additional solvents, carriers, or binders (not shown) may be present in uniform mixture 13 as may be desired or required to accomplish the following steps.

The application of the resulting composite mixture from the mixing step to the vertical surface of a substrate 14 is indicated at 16. More than one application step 16 may be employed if required or desired. Multiple application steps may be of the same or different types, for example, a brushing type step may be followed by a spraying type step. The nature of the application step(s) and the composite mixture are such that the composite mixture is loosely adhered to the vertical surface of substrate 14 in a thin substantially uniform layer 18 that remains on the surface substantially where applied until that layer is subjected to pulsed heating conditions. The nature of the application step(s) and, to a certain degree, the compositions of the composite mixtures are adapted to the orientation and shape of the substrate 14. For example, a horizontal downwardly facing substrate surface and a horizontal upwardly facing substrate surface may require different types of applications and/or different solvents, carriers, or binders to assure the adherence of the composite mixture to the surface of the substrate.

A pulsed heat source 20 is juxtaposed to the composite mixture on the surface, and one or more pulses of heat energy 22 is applied to the composite mixture on the surface of substrate 14. Pulsed heat source 20 generally heats by emitting a beam of high intensity electromagnetic radiation in what is seen as a pulse when viewed from what fusion layer 24 on the substrate sees. The pulse effect may be achieved by relative movement between the pulsed heat source 20 and substrate 14, or by rapidly turning heat source 20 on and off, or by moving a slit in a shutter between pulsed heat source 20 and fusion layer 24, or the like. According to certain embodiments, this electromagnetic radiation is in the peak absorption band of the composite mixture, which is often in about the 0.2 to 0.12 micron wavelength range. The matrix phase precursor in the composite mixture on the surface of a substrate is thermally fluidized to form a fusion layer of fluidized composite mixture as indicated at 24. Any solvents, carriers, binders, or other materials in the composite are either driven off by the heat or combined with the fusion layer. Region 26 is very rapidly heated by a pulse or pulses of heat energy 22 from heat source 20. Heat energy is applied for about 0.1 to 10 seconds to rapidly heat the region 26. The heat flux is from about 150 to 3,500, or in some embodiments, from about 700 to 1700 Watts per square centimeter. The level of the heat flux and the duration of its application are such that the composite mixture 18 is very rapidly fluidized, but the total amount of heat is minimized. Fluidization is sufficiently complete that the finished composite layer 30 exhibits substantially full density with essentially no open porosity. The peak temperature of the fusion layer is, in certain embodiments, as much as approximately 100 to 150 percent of the melting point of the matrix phase precursor, and in other embodiments from approximately 400 to 4,000 degrees Celsius. Region 26 includes substantially all of the fusion layer 24, and, often, a small section at or adjacent the surface of substrate 14 to which fusion layer 24 is adhered.

The application of heat energy 22 is discontinued, and quenching immediately takes place by reason of the transfer of heat from the fusion layer 24 into the substrate 14. The mass of substrate 14, compared to that of the relatively much thinner fusion layer 24 is such that quenching to the point where the fusion layer 24 has solidified into composite layer 28 occurs quickly, and without elevating the average temperature of substrate 14 to the point where the physical properties of substrate 14 are significantly thermally damaged.

The physical properties of zone 30, which is immediately adjacent composite layer 28, may be altered when the density and duration of the application of heat energy 22 are sufficient to provide a large amount of total heat energy. Such a condition occurs, for example, when sufficient heat energy is applied to cause the formation of a metallurgical bond between substrate 14 and composite layer 28. Where such an alteration of substrate properties occurs, that alteration is confined to zone 30 by limiting the duration and density of heat energy 22 to that which is just sufficient to achieve the desired result. Zone 30 is relatively very thin as compared to the overall thickness of substrate 14. This alteration of properties generally results in the degradation of the overall properties of substrate 14 by no more than approximately 5 percent. Most structural elements are designed with a safety factor to withstand a load that is at least 20 percent greater than the nominal maximum design load. Where necessary, the safety factor may be increased by approximately 5 percent, or the degradation of the safety factor to 15 percent may be acceptable for certain applications. The 5 percent degradation of the overall physical properties of a substrate is not considered to be significant.

The particle sizes of the ceramic phase generally fall into 3 ranges, each of which influences the properties of the fusion layer or composite layer in a different way. Nanoscale ceramic particles are generally considered to have particle sizes ranging from approximately 3 to 100 nanometers. Submicron ceramic particles, or as they are sometimes described, ultrafine particles generally have particle sizes ranging from approximately 100 nanometers to 1,000 nanometers (1 micron). Micron scale ceramic particles, or as they are sometimes described, macro particles generally have particle sizes ranging from approximately 1 micron to 1,000 microns.

Nanoscale ceramic phase particles when present at or above approximately their percolation threshold cause both the liquid and solid phases of the matrix to resist deformation. Nanoscale ceramic phase particles thus help to prevent the fusion layers from slumping or otherwise flowing from where they are formed. Since the percolation threshold for nanoscale ceramic phase particles is very low, sometimes as low as 0.05 or 0.5, and often no more than approximately 5 volume percent based on the total volume of the matrix, low concentrations of such nanoscale ceramic phase particles are very effective. In general, concentrations of nanoscale ceramic phase particles in excess of 15 volume percent do not result in additional significant improvements in the properties of either the fused layer or the composite layer. Micron scale ceramic phase particles are particularly useful in increasing the abrasion and wear resistance of the composite layer. In bimodal nanoscale:micronscale mixtures of ceramic phase particles the ratio of the nanoscale to micronscale sizes ranges from about 1:10 to 1:10,000. The amount of micronscale ceramic phase particles in some embodiments may be as much as 3 to 6 times the volume percent of the nanoscale ceramic phase particles in order to achieve the desired abrasion and wear resistant properties. In general, the total ceramic phase should not exceed 85, or in further embodiments 75 volume percent of the total fused layer or composite layer. In certain embodiments submicron scale ceramic phase particles may be used in place of micronscale ceramic phase particles. The presence of nanoscale particles with micronscale particles in a bimodal ceramic phase helps control the distribution of the micronscale particles in the matrix. The nanoscale particles tend to prevent the micronscale particles floating or sinking in the fluidized matrix by reason of different densities. The nanoscale ceramic phase particles also serve to improve wear resistance by minimizing wear debris at high temperatures and under conditions of poor or no lubrication. Also, in turbines at 1,000 to 1,2000 degrees Celsius the nanoscale particles tend to prevent deformation of the composite layer. It is believed that the nanoscale particles minimize wear debris by acting as tiny ball bearings.

The ceramic phase particles are generally smaller, and, in some embodiments, at least an order of magnitude (10 times) smaller than the fluidizable matrix forming materials. The size of the fluidizable matrix forming materials (metallic or polymeric) is generally a consideration in forming a uniform composite mixture, and in achieving the desired thickness for the composite layer, but not in accomplishing fluidization in the heat application step. The amount of applied heat flux is sufficient to fluidize the matrix forming materials. The ceramic phase particles are often carried on the surface of the matrix forming particles to achieve a uniform composite mixture. Other conventional blending procedures may be used to achieve a substantially uniform composite mixture.

The application of the composite mixture of a substrate to form a composite mixture layer may be accomplished using conventional procedures. The temporary adhesion of the composite mixture layer to the substrate may be accomplished by either wet or dry conventional application methods. Carriers, adhesives, binders, or other application enhancers may be employed so long as they do not adversely change or influence the properties of the composite layer. Heat may be applied within seconds or minutes of forming the composition mixture layer.

Those embodiments in which the ceramic phases particles are formed in situ in the fusion layer require the presence of a ceramic phase precursor in the composite mixture layer. Such ceramic phase precursors are known, and include, for example, aluminum, which reacts with oxygen in the air to form aluminum oxide, or mixtures of iron oxide and aluminum and iron or nickel, which react to form aluminum oxide.

The temperatures that are reached in the fusion steps for many embodiments are such that the ceramic phases usually undergo some physical attack by the molten phases in the fusion layer. Embodiments of the ceramic phases should be such that at least approximately half of the particles survive such physical attacks as discrete identifiable particles. For example, no more than half of the average ceramic phase particle should be dissolved into the matrix phase.

Embodiments of the composite layers may range in thickness from, for example, 30 percent or less of the thickness of the substrate, or in further embodiments, from approximately 10 to 10,000 microns. Matrix grain sizes generally decrease as the composite layer thickness decreases. For example, composite layer with thicknesses of less than 100 microns should generally have matrix grain sizes below 1 micron.

The total amount of heat applied to create a fusion layer should be controlled so that a previously heat treated substrate does not require subsequent annealing or heat treating to restore its physical properties. That is, the temper properties of the substrate do not need to be restored after the composite layer is formed. According to certain embodiments, even when a metallurgical bond is formed between the composite layer and the substrate, the heat altered zone of the substrate is less than about 3 millimeters deep into the substrate. In certain further embodiments, the thickness of the interdiffusion zone of the metallurgical bond is from about 0.0001, or 0.001, or 0.005 millimeters to 0.025 or 0.1 millimeters.

The fusion layer is rapidly quenched. Quenching occurs rapidly because in many embodiments the total amount of heat is limited to just that required to form the fluidized fusion layer, and it is applied very quickly in one or more pulses. In many embodiments, the total mass of the fusion layer is small compared to that of the substrate so the substrate is able to soak up the heat without raising its temperature to a level where the thermally degradable properties of the substrate are adversely changed. Gas cooling of the fusion layer may be employed, if desired, to limit the amount of heat that the substrate must absorb. This tends to protect the substrate from exposure to excessive heat. Also, the use of gas cooling tends to increase the quenching rate. Where the matrix is an amorphous alloy, the fusion layer should be quenched as rapidly as possible to prevent the amorphous alloy from crystallizing.

Certain embodiments are particularly suitable for use in forming composite layers from composite mixtures on heat sensitive substrates. In certain embodiments, the resulting composite layers are in the form of micro- or nanocrystalline films bonded to the substrates. The substrate with a composite layer overlayed on it may be welded, formed, or processed to form a finished article.

According to certain embodiments, composite mixtures can be applied to form composite layers, for example, by electrostatic spray, powder spraying, brushing, rolling, or other layer application operations, which composite layers are then rapidly fused into fluidized fusion layers on heat sensitive substrates. The operations by which the composite layers are applied to substrates is such that the composite layers are adhesively applied as a substantially uniform mixture to a surface of a substrate to form a layer of the substantially uniform composite mixture adhered to that surface. The adhesion is sufficient to hold the composite layer on the surface until the fusion step is commenced.

Typical heat sensitive substrates include those that include, for example, high strength steel, stainless steels, Inconel, aluminum, and their respective alloys and mixtures. Because high heating rates are used, and the thin fusion layers are quickly quenched by the relatively thicker substrates, the mechanical properties of the substrate are not significantly changed by the fusion step. Such composite mixtures may be applied, fused, and bonded at very high rates onto vertical and horizontal surfaces without beading or running off the substrate. The resultant composite layers exhibit superior corrosion, thermal and wear resistant properties that provide significantly longer life than conventional zinc containing primer coatings or galvanized coatings, particularly in hostile environments where accelerated corrosion is experienced. According to certain embodiments, the resulting composite layers are without any visual evidence of out-gassing, bubbling, or pinhole formation. These composite layers exhibit continuous, corrosion resistant finishes.

According to certain embodiments, rapid fusion of a composite mixture layer that has been formed on a heat sensitive substrate is accomplished, for example, by applying a burst of medium to high intensity infrared, radio frequency, or laser heating to the loosely adhered layer of composite mixture followed by rapid quenching. Composite layers may thus be applied at high rates onto heat sensitive substrates.

According to certain embodiments, maximum average substrate temperatures of only approximately 350 degrees Fahrenheit (177 degrees Celsius), or less, are experienced in achieving acceptable properties without damaging or worsening the properties of the substrate. The fusion layers may experience substantially instantaneous temperatures of approximately 400 to 2,000 degrees Celsius during the fusion step. Satisfactory composite layers are achieved, particularly when a composite layer is formed onto heat sensitive substrates such as, for example, HSLA steels, titanium, ceramics, and high temperature thermoset organic or inorganic polymers, by, for example, utilizing a quick pulse of high intensity infrared energy in a fusion step, followed by rapid quenching. Rapid quenching of the fusion layer is accomplished by the relatively thick substrate's quickly absorbing heat from the relatively much thinner fusion layer.

One or more pulses of heating energy at the same or different energy levels may be applied, as may be desired to obtain a specified thermal profile. Different sources of heating energy, for example, infrared and radio frequency may be used to apply different energy pulses. Regardless of the heat source, the composite layer on the substrate sees a quick high energy pulse for a short duration that very quickly fluidizes the composite layer. The total amount of heat applied in this burst of energy is mostly concentrated in the fusion layer, and is not sufficient to significantly heat the substrate.

Production operations may employ continuous operations on, for example, pipes, pipelines, infrastructure components such as, for example, bridge and highway structural elements, docks, building frame elements, marine vessel hulls and other components, aircraft structural elements, land vehicle bodies and components, reinforcing bar, and the like. According to certain embodiments, in certain manufacturing operations the substrates that are to be overlayed with a composite layer are moved continuously past sequential layer application, fusion and quenching stations. Inert gas atmospheres such as, for example, nitrogen or argon may be provided at the various stations as may be required to protect the product from contamination, and to provide cooling for the fluidized fusion layer.

According to certain embodiments, composite mixtures are in particulate form, and comprise a substantially uniform powdered blend of metal matrix precursor, and ceramic phase particles. These ceramic particles, according to certain embodiments, exhibit average particle sizes of from approximately 3 or 10 nanometers to 100 nanometers, or 1,000 nanometers (1 micron), and according to additional embodiments, have an average size of below approximately 500 or 100 nanometers. Bimodal nanoscale:micronscale ceramic particle size distribution of from approximately 0.1 to 0.5 (100 to 500 nanometers), and approximately 3 to 15 microns may be advantageously employed. The ceramic particles generally are not melted or significantly decomposed during the fusion step, although they may be altered somewhat as to shape and size.

The nanoscale particulate ceramic phase serves several purposes. It efficiently adsorbs infrared wavelengths to promote rapid fusion, and it increases the viscosity and reduces the surface tension of the fluidized fusion layer that is produced in the fusion step. This provides the fusion layer with time to solidify without slumping or beading up on the surface of the substrate. The grain size of the matrix in the finished composite layer is minimized by the presence of the nanoscale particulate ceramic phase, and the resistance to distortion of the finished composite layer is also improved by the presence of the nanoscale ceramic phase particles. In bimodal embodiments, the larger micronscale ceramic particles generally serve to minimize abrasion and increase wear resistance.

According to certain further embodiments, the composite mixtures are in particulate form and comprise a substantially uniform blend of a thermosetting organic or inorganic resin system matrix precursor with a submicron/nanoscale particulate ceramic phase.

According to certain embodiments, the volume fraction of the particulate ceramic phase in the composite mixture is selected so that the nanoscale sized particulate ceramic phase in the fused composite layers are approximately at or above the percolation threshold. Percolation is a statistical concept that describes the formation of an infinite cluster of connected particles or pathways. At the percolation threshold, the nanoscale ceramic particles are believed to form a continuous path, thereby restraining and controlling the flow of the fusion layer, and enabling densification and flow to take place without beading or slumping of the layer. Nanoscale ceramic phase particulates have a particular advantage in that their percolation threshold is reached at concentrations as low as 0.05 to 5, or 5 to 7 volume percent, meaning that very small additions can have tremendous effects on the flow properties of materials when they are in a fluid state. In certain embodiments, such very small additions of nanoscale ceramic phase particulates also have a substantial effect on the flow properties of the finished solid phase composite layers. Volume percents of such nanoscale ceramic particulates of from approximately 0.05 to 15 volume percent may be advantageously employed in the fusion layers. A second aspect of the use of such nanoscale ceramic phase particulates in certain embodiments is that they effectively constrain and refine the grain size of corrosion resistant metal alloy matrix during solidification. This provides a dramatic increase in performance as regards corrosion and wear resistance. Both the corrosion and wear resistance of a composite layer generally increase as the grain size of the metal matrix alloy decreases.

According to certain embodiments, the fusion step may be accomplished by the use of electromagnetic radiation, for example, an infrared lamp operated at a power density of from approximately 150 to 350, or in further embodiments from approximately 150 to 1700, or 150 to 3,500, or 700 to 1700 watts per square centimeter. The fusion step may also be accomplished through the use of a focused arc lamp, an argon or xenon arc lamp, a long arc lamp, a diode pumped laser, a source of radio frequency energy operated at from approximately 40 or 80 to 450 kilohertz, combinations of such heat sources, and the like. The resulting finished composite layers, according to certain embodiments, have a thickness of from approximately 0.1 or, in further embodiments, 0.2 to 0.0001 inches, more or less.

According to certain embodiments, the fusion step in which the matrix is fluidized includes a rapid, high heat flux, pulse heating process to enable deposited layers of composite mixtures to be fused at high rates and with minimal thermal impact on the properties of the substrate. By heating a layer of deposited composite mixture at heat fluxes of from approximately 150 to 3500 watts per square centimeter, the layer can be heated to temperatures of from approximately 200, or in other embodiments, 400, to 2000, or in further embodiments, 4,000 degrees Celsius in under a second. By keeping the heat flux duration to a short pulse or exposure, very little heat input (in terms of Joules per cubic centimeter) is imparted into the substrate. This limits both the substrate's temperature rise and the size of the heat affected zone. Rapid quenching of the resulting fused composite layer by the substrate is accomplished with or without the aid of gas jets. The submicron/nanoscale particulate ceramic phase provides a large number of particle nucleating sites. The combination of short duration, high heat flux exposures, and high quench rate in the fusion step provides corrosion resistant alloy matrices that are highly refined, and exhibit micron- and nano-grain sizes. The physical properties of the final composite layers, including hardness and wear resistance, are considerably improved by the presence of such small grain sizes in the matrix material. Refining the grain size in the matrix to approximately the 10 to 500 nanometer range, and in some embodiments to approximately the 30 to 300 or even 100 nanometer size range results in a significant improvement in durability, wear, and corrosion resistance of the product. Matrix grain sizes of less than approximately 3 or in some embodiments 1 microns provide satisfactory results.

Previously, various additives and modifiers had been proposed for various purposes in forming and using different cermet products. Such additives include, for example, wetting agents, grain growth inhibitors, melting point adjustment agents, and the like. Modifiers and additives typically serve to promote adhesion, or limit grain growth, or limit diffusion or reaction, or otherwise modify melting temperatures, physical, mechanical, or chemical properties, or the like.

According to certain embodiments, all of the materials that go into the finished composite layers are contained in the composite mixture. Thus, for such embodiments, the composition and physical configuration of the composite layers are at least primarily determined by the content of the composite mixtures, together with the conditions under which the fused composite layers are formed.

Composite layers according to certain embodiments are formed in situ on a surface of a substrate. That is, the finished composite layers form in place from a more or less fluid state as compared with being formed somewhere else, transferred to and applied to the surface of the substrate. Being formed in situ from an approximately fluid state causes the composite layers to bond as tightly as possible to the substrates. Where the bonding is mechanical, the formed in situ composite layer conforms in minute detail to the supporting surface of the substrate in a way that is generally impossible to achieve with a separately formed layer. The in situ forming permits the composite layer to conform to arcuate or angular surfaces, or surfaces where anchoring configurations or roughness have been deliberately provided.

The composite layer is conveniently formed on a flat, arcuate, or angular surface of a substrate. The substrate, in most embodiments, has physical characteristics that differ from those of the composite layer. In certain embodiments, the substrate supports and lends strength to the composite layer, and the composite layer provides wear resistance and hardness to the substrate. Where metallurgical bonding is required, the surface of the substrate can be pre-coated with an adhesion promoter. Adhesion promoters include, for example, aluminum or other elements that form low melting alloys with the metal matrix. Where mechanical bonds are to be formed, the bonding surface of the substrate can be roughened or porous.

According to certain embodiments, the particulate matrix phase precursor that is associated with the composite mixture when it is applied to a substrate can be, for example, in the form of a more or less loosely adhered deposit of particles, particles in loose but intimately mixed association with the particulate ceramic phase.

The composite mixtures, according to certain embodiments, are fusion-processable powders that are melt processable, and include a nanoscale particulate ceramic phase and a particulate matrix phase precursor. Such particulate matrix phase precursors include, for example, thermosetting organic or inorganic polymers, and metallic materials. Suitable organic polymers include, for example, fusion bondable epoxy resin. Suitable particulate metal matrix phase precursors, according to certain embodiments, include metallic elements, mixtures, and alloys that will fuse under pulse heating conditions, do not react to a significant degree with the associated nanoscale particulate ceramic phase, do not dissolve such associated fillers to a significant degree, and, when processed into composite layers, posses the physical properties that are desired. Such properties include, for example, hardness, wear resistance, ductility, compatibility with the associated substrate, and corrosion resistance.

Metallic elements, alloys and mixtures that are suitable for use in particulate matrix phase precursors include, for example, alloys of nickel, such as, nickel-chromium, nickel-zinc, nickel-copper, nickel titanium, nickel-cobalt, nickel-molybdenum alone or with other elements such as silicon, phosphorous, boron, aluminum, or the like. Additional such particulate matrix phase precursor materials include, for example, cobalt alloys such as cobalt-chromium, cobalt-aluminum, cobalt-molybdenum alone or with other elements such as silicon, phosphorous, or aluminum, or the like. Further such particulate matrix phase precursor materials include, for example, aluminum alloys such as, for example, aluminum-zinc and aluminum-magnesium, zinc alloys such as, for example, zinc, aluminum-magnesium, copper alloys, titanium alloys, mixtures and alloys of the above listed elements, and the like. Certain embodiments that employ cobalt-chromium alloys contain from approximately 15 to 45 or 20 to 30 weight percent of chromium, and may include from approximately 3 to 15 weight percent aluminum. Silicon, phosphorus, or boron may also be included in amounts from approximately 1 to 5 or 6 or 13 weight percent. Aluminum-zinc alloys may include, for example, from approximately 0.5 to 2 weight percent of magnesium. Further embodiments comprise stainless steels, alloy 22, 625 or 825 nickel alloy, C276 corrosion resistant alloys, or Ni—Cu alloys. Metals and metalloids that are suitable for use in matrix phase precursors according to the present invention are those that are fluidizable under the pulse heating conditions that are applied in embodiments of the present invention. Such metals and metalloids include, for example, refractory metals such as tungsten, rhenium, tantalum, zirconium, hafnium, and niobium, iron, nickel, cobalt, manganese, magnesium, molybdenum, titanium, tin, cadmium, lead, vanadium, chromium, aluminum, boron, silicon, palladium, platinum, gold, silver, copper, and the like.

According to certain embodiments, suitable ceramic phase materials include conventional ceramics. Oxide ceramics include for example, silica, alumina, aluminosilicate, zirconia, zircon, titania, garnet, chromium oxide, yttrium oxide, neodymium oxide, gadolinium oxide, spinel, or the like. Carbide, boride, silicide, and nitride ceramics include, for example, silicon carbide, silicon nitride, titanium nitride, zirconium carbide, niobium carbide, niobium nitride, cubic boron carbide, chromium carbide, titanium boride, and the like. The ceramic phase may include various metals and metalloids, including, for example, chromium, silicon, aluminum, nickel, iron, manganese, molybdenum, niobium, titanium, zirconium, tantalum, vanadium, or tungsten. In certain embodiments, submicron/nanoscale particulate ceramic phase materials are present in amounts above their percolation threshold, and generally in amounts such that such ceramic phases in the composite mixtures comprise from approximately 5 to 65, or, in further embodiments, from 25 to 45 volume percent of such composite mixtures. In certain embodiments, during the fusion step, from approximately 10 to 65 or 30 to 55 volume percent of the composite mixtures remain in the solid state.

Suitable substrates, according to certain embodiments include, for example, conventional high strength alloys such as X40, X65, X80, X100, 4140, 4340, MAR300, and 52100.

### Example 1

The objective of this test was to determine the feasibility of controlling the viscosity of a standard thermal spray powder when fused using a plasma arc lamp. A standard powdered blend (Metco's 73F) of WC, with 17 percent (by weight) Co was obtained. 3.5 volume percent of SIC powder with an average size of 90 nanometers was added and the mixture was mechanically agitated to produce a blend. A conventional polymer carrier (LISI 10018, by Warren Paint Color Co.) was then added to the powder mixture to form composite mixture in slurry form. This composite mixture was then applied to the surface of a substrate (cold rolled 4340 steel) in the form of a coupon (3×6×⅛ inches) using a conventional automotive paint sprayer. The resulting composite mixture layer was allowed to dry. The coated coupon was then de-bound in an inert atmosphere at a temperature of 450 degrees Celsius for 10 minutes and allowed to cool to room temperature. There was essentially no remaining polymer carrier in the coating. The coated and de-bound coupon was then placed in a process box to allow for inert cover using Ar gas. The coating was then fused by scanning a plasma arc lamp over the coupon with a fluence of 2,250 Watts per square centimeter at a rate of 20 millimeters per second to produce a fluidized fusion layer. The average length of exposure to the heat source for any location on the coupon was about 1.3 seconds. The average peak temperature of the fusion layer was estimated to be approximately 1,400 degrees Celsius, and the average substrate temperature was estimated to be approximately 550 degrees Celsius. The substrate absorbed some heat from the composite layer. The coupon with the resulting composite layer was allowed to cool by natural convection. A dense composite layer was recovered from this process in which there was less than 2 percent open porosity. The composite layer was very uniform in thickness with a thickness of about ⅛ inches. The substrate had a thickness of from about 250-400 microns. The properties of the substrate were changed by the heat of the operation to a depth of approximately 300 microns from the surface into the coupon. There was some degradation (less than 50 percent) of the WC particles where WC was absorbed into the matrix forming a core-in-shell structure. The SiC particles were largely unaffected.

A similar composite layer was produced by mixing the WC—Co and SiC powders separately with the polymer carrier and agitating the mixture with a paint mixer.

A similar composite layer was produced without the added step of de-binding the carrier prior to fusion. Porosity of the finished composite layer increased to between 6 and 8 percent, but other properties remained largely unchanged.

A similar composite layer was produced by rapidly quenching using He gas. The composite layer was similar to that described above, but the heat affected zone in the substrate was slightly narrower, approximately 250 microns.

The addition of about 10 volume percent of the SiC nanoparticles resulted in a composite layer with elevated porosity. The porosity was greater than 15 percent, and it was interconnected (open) porosity. Agglomeration of the SiC powder was observed, and there was poor distribution of the binding (metal) matrix.

### Example 2

The purpose of this example was to investigate new compositions for hardfacing materials. A Ni—P matrix with a particle size range about minus 1 millimeter to about plus 325 Mesh was manually blended with TiB₂ having an average particle size of about 45 microns. An organic polymer precursor was then added to the powders to form a composite mixture. The resulting composite mixture was then applied to the substrate material (a cold rolled 3×6×⅛ inch coupon of 4340 steel) with an automotive style paint spray gun to a thickness of approximately 250 microns. The applied composite mixture layer was allowed to dry. A laser with an elliptical spot having major and minor axes of approximately 6 millimeters and 1.5 millimeters, respectively, was used to fuse the composite mixture layer into a fusion layer. The laser was operated at a power of approximately 2,000 Watts and at a scan rate of 1,200 millimeters per minute. The coupon with the fusion layer was quenched by thermal conduction into the substrate. The composite layer formed a metallurgic bond with the surface of the substrate, which had a heat affected zone of approximately 150 microns in depth. Some cracking of the composite layer was observed.

A thinner coating with less cracking was produced by dipping the substrate in a bath of precursor material instead of using a spray coating method.

### Example 3

The purpose of this example was to evaluate the ability to increase the hardness of Ni—Cr—Cr₂C₃ coatings. A nickel-chrome-chrome carbide coating was produced by mixing Ni, Cr and Cr₂C₃ powders where the Cr₂C₃ material contained an excess of C. The Cr₂C₃ powder had a particle size range of 15-63 microns. The dry powders were mixed with a polymer carrier using a ball mill and the resulting slurry was applied to the surface of a substrate in a uniform layer using a paint brush. The material was fused using a plasma arc lamp with a fluence of approximately 1,850 Watts per square centimeter, and a scan rate of 10 millimeters per second. The coating was cooled convectively. The resulting coating had a bimodal Cr₂C₃ distribution where additional, smaller Cr₂C₃ particles of less than 500 nanometer in average size were formed through the combination of Cr and C during processing. The amount of Cr₂C₃ formed in-situ was dependent upon the amount of excess C and varied with Cr₂C₃ manufacturer. The hardness of the finished composite layer was about R_{c}=37.

### Example 4

The purpose of this proposed example is to demonstrate the processing of thermoplastic composite layers using high energy density infrared processes. 5 volume percent of TiO₂ powder having a particle size of about 50 nanometers is added to finely divided polypropylene, and mechanically blended to form a homogeneous mixture. The resulting powdered composite mixture is then applied in a uniform layer of approximately 1 millimeter in thickness to a cold rolled 4340 steel substrate, and heated using a tungsten halogen lamp with a power density of 150 Watts per square centimeter. The thermoplastic material is melted through heat absorbed by the TiO₂ particles and by heat absorbed into the overall body of the fusion layer. The fusion layer is prevented from sagging/running by the TiO₂ particles.

Repeating this Example 4 with the addition of 45 volume percent of SiC will produce an increase in hardness resulting in an increase in durability.

### Example 5

The purpose of this prospective example is to demonstrate the ability to improve the hardness of thermosetting polymers while maintaining the toughness. 1.5 volume percent of 10 nanometer Al₂O₃ is added to polyurethane powder and blended mechanically to form a homogeneous mixture. A solvent is added to form a composite mixture in slurry form. The slurry is applied to a substrate with a paint roller. The applied composite mixture layer is then fused using a plasma arc lamp operating at 150 Watts per square centimeter. The plasma arc lamp is scanned across the composite mixture layer at a rate of approximately 30 millimeters per second. This application of heat results in melting of the composite mixture layer to form fluidized a fusion layer, which resists balling up on the surface of the substrate due to the addition of the nanoscale ceramic phase. The fluidized fusion layer then solidifies due to a combination of the thermosetting process and conductive heat transfer to the substrate material.

### Example 6

The purpose of this prospective example is to demonstrate the ability to increase the ceramic content of a coating to improve its wear characteristics. A Si₃N₄ powder with a bimodal distribution where one mode occurs at approximately 50 nanometers, and is responsible for about 5 volume percent of the finished composite layer, and the second mode occurs at approximately 500 nanometers, and is responsible for about 60 volume percent of the finished composite layer, is added to a Ni-20 (weight percent) Cr matrix. The mixture is mechanically alloyed using an attrition mill with a liquid carrier. The resulting composite mixture is removed from the attrition mill and applied to a substrate as a slurry, and fused using a plasma arc lamp with a power density of approximately 1,650 Watts per square centimeter and a scan rate of about 10 millimeters per second. The resulting fluidized fusion layer cools due to thermal conduction into the substrate and has a hardness of approximately HV 1000.

While exemplary embodiments are described above, it is not intended that these embodiments describe all possible forms of the invention. Rather, the words used in the specification are words of description rather than limitation, and various changes may be made without departing from the spirit and scope of the invention. Additionally, the features of various implementing embodiments may be combined to form further embodiments of the invention.

What is claimed is:

1. A method of manufacturing a composite layer containing a nanoscale ceramic phase in a metal matrix phase, said method comprising:
selecting a matrix phase precursor, said matrix phase precursor comprising metallic powder that is fusible under a pulse heating condition;
providing for said nanoscale ceramic phase;
applying a composite mixture that includes at least said matrix phase precursor to a substrate to form a composite mixture layer on said substrate, said substrate having thermally degradable physical properties, said composite mixture layer being sufficiently adhered to said substrate to remain substantially where applied until subjected to said pulse heating condition;
subjecting said composite mixture layer to said pulse heating condition, said pulse heating condition comprising applying a heat flux of from about 150 to 3,500 watts per square centimeter for a period of from under 0.1 second to about 10 seconds resulting in a fusion layer in which said metallic powder in said matrix phase precursor is fluidized and said nanoscale ceramic phase is substantially uniformly dispersed in a resulting fluidized matrix, said fusion layer remaining on said substrate without significant slumping or beading, said nanoscale ceramic phase being present in said composite mixture layer in an amount above about its percolation threshold; and
quenching said fusion layer to form said composite layer, said quenching comprising allowing enough heat to transfer from said fused layer to solidify said fusion layer without significantly degrading said thermally degradable physical properties.

2. A method of claim 1 wherein said providing comprises adding a nanoscale powdered ceramic phase to said powdered metal to form said matrix phase precursor.

3. A method of claim 1 including providing a ceramic phase precursor in said composite mixture and allowing said nanoscale ceramic phase to precipitate in said fusion layer.

4. A method of claim 1 wherein said subjecting includes establishing relative motion between said substrate and said source of said heat flux.

5. A method of claim 1 wherein said providing includes providing a ceramic phase having a nanoscale:micronscale bimodal particle size distribution of from approximately 3 to 100 nanometers and from approximately 1 to 1,000 microns, respectively, said nanoscale ceramic phase being present in an amount of from approximately 0.05 to 15 volume percent, and the total volume percent of said ceramic phase being less than about 85 volume percent.

6. A method of claim 1 wherein said applying includes applying a heat flux from an infrared, radio frequency or laser heating source.

7. A method of claim 1 wherein said subjecting includes subjecting said composite mixture to more than one said pulse heating condition.

8. A method of claim 1 wherein said subjecting comprises applying enough total heat to said composite mixture to raise the temperature of said fusion layer to from 100 to 150 percent of the melting point of said powdered metal in said matrix phase precursor.

9. A composite layer on a substrate, said composite layer being substantially pore free and comprising a nanoscale ceramic phase in a metallic matrix, said nanoscale ceramic phase being present in an amount of at least about its percolation threshold, and from about 0.5 to 15 volume percent.

10. A composite layer of claim 9 wherein said metallic matrix has an average grain size of less than 30 microns.

11. A composite layer of claim 9 wherein said metallic matrix has an average grain size of less than 10 microns.

12. A composite layer of claim 9 wherein said metallic matrix has an average grain size of less than 5 microns.

13. A composite layer of claim 9 wherein said metallic matrix has an average grain size of less than 1 micron.

14. A composite layer of claim 9 wherein said metallic matrix has an average grain size of less than 5 microns, said nanoscale ceramic phase being present in an amount of from about 0.5 to 5 volume percent.

15. A composite layer of claim 9 including a micron-scale ceramic phase in an amount of from approximately 1 to 75 volume percent with an average particle size of from 1 to 1,000 microns.

16. A composite layer of claim 9 wherein said metallic matrix comprises an amorphous metal alloy.

17. A method of manufacturing a composite layer containing a nanoscale ceramic phase in a non-metallic matrix phase, said method comprising:
selecting a matrix phase precursor, said matrix phase precursor comprising polymeric powder that is fluidizable under a pulse heating condition;
providing for said nanoscale ceramic phase;
applying a composite mixture that includes at least said matrix phase precursor to a substrate to form a composite mixture layer, said polymeric powder having a decomposition temperature above which said polymeric powder decomposes, said substrate having thermally degradable physical properties, said composite mixture layer being sufficiently adhered to said substrate to remain substantially where applied until subjected to said pulse heating condition;
subjecting said composite mixture layer to said pulse heating condition, said pulse heating condition comprising applying a heat flux of from about 150 to 1,700 Watts per square centimeter for a period of from under 0.1 second to about 10 seconds until said composite mixture layer reaches a temperature at which said polymeric powder becomes fluidized, but below about said decomposition temperature, resulting in a fluidized layer in which said nanoscale ceramic phase is dispersed, said nanoscale ceramic phase being present in an amount above about its percolation threshold, wherein said fluidized layer remains on said substrate without significant slumping or beading; and
quenching said fluidized layer to form said composite layer, said quenching comprising allowing enough heat to transfer away from said fluidized layer to solidify said fluidized layer without significantly degrading said thermally degradable physical properties.

18. A method of manufacturing of claim 17 wherein said quenching includes allowing said matrix phase precursor to cross-link to a solid thermoset condition.

19. A method of manufacturing of claim 17 wherein said matrix phase precursor includes an organic polymer.

20. A method of manufacturing of claim 17 wherein said matrix phase precursor includes an inorganic polymer.

21. A method of manufacturing of claim 17 wherein said matrix phase precursor includes a thermosetting polymer.

22. A method of manufacturing of claim 17 wherein said matrix phase precursor includes a thermoplastic polymer, and said quenching includes allowing said thermoplastic polymer to become solid.

23. A composite layer on a substrate, said composite layer being substantially pore free and comprising a nanoscale ceramic phase in a solid phase non-metallic matrix, said nanoscale ceramic phase being present in an amount of at least about its percolation threshold and from about 0.5 to 15 volume percent.

24. A composite layer of claim 23 wherein said composite layer comprises a ceramic phase having a nanoscale:micron-scale bimodal particle size distribution of from approximately 3 to 100 nanometers and from approximately 1 to 1,000 microns, respectively, said nanoscale ceramic phase being present in an amount of from approximately 0.05 to 15 volume percent, and the total volume percent of said ceramic phase being less than about 85 percent.

25. A method of manufacturing a composite layer containing a nanoscale ceramic phase in a metal matrix phase, said method comprising:
selecting a matrix phase precursor, said matrix phase precursor comprising metallic powder that is fusible under a pulse heating condition and has a metallic melting point;
providing a ceramic phase precursor, said ceramic phase precursor comprising nanoscale ceramic particles with an average particle size of from approximately 3 to 100 nanometers and a ceramic melting point that is at least 100 degrees Celsius above said metallic melting point;
mixing said matrix phase precursor and said ceramic phase precursor to form a composite mixture that is substantially uniform;
applying said composite mixture to a substrate to form a composite mixture layer on said substrate, said substrate having thermally degradable physical properties that degrade at temperatures below said metallic melting point, said composite mixture layer being sufficiently adhered to said substrate to remain substantially where applied until subjected to said pulse heating condition;
subjecting said composite mixture layer to said pulse heating condition, said pulse heating condition comprising applying a heat flux of from about 150 to 3,500 watts per square centimeter for a period of from under 0.1 second to about 10 seconds resulting in a fusion layer in which said metallic powder in said matrix phase precursor is fluidized and said nanoscale ceramic phase is substantially uniformly dispersed in a resulting fluidized matrix, said fusion layer remaining on said substrate without significant slumping or beading, said nanoscale ceramic phase being present in an amount above about its percolation threshold; and
quenching said fusion layer to form said composite layer, said quenching comprising allowing enough heat to transfer from said fused layer to solidify said fusion layer without significantly degrading said thermally degradable physical properties.

26. A method of manufacturing of claim 25 wherein said applying a heat flux comprises applying a heat flux of from about 700 to 1,700 watts per square centimeter
